(19) United States
(12) Patent Application Publication
(10) Pub. No.: US 2022/0389261 A1
(43) Pub. Date: Dec. 8, 2022

(54) Method of producing nanocellulose films

(71) Applicant: Åbo Akademi, Åbo (FI)

(72) Inventors: Rajesh Koppolu, Åbo (FI); Martti Toivakka, Åbo (FI)

(21) Appl. No.: 17/785,934

(22) PCT Filed: Dec. 16, 2020
(86) PCT No.: PCT/FI2020/050842

§ 371 Date: Jun. 16, 2022

(30) Foreign Application Priority Data
Dec. 16, 2019 (FI) 20196087

(51) Int. Cl. C09D 101/02; C08J 5/18; B82Y 40/00

(52) U.S. Cl. CPC C09D 101/02; C08J 5/18; B82Y 40/00; C08J 2301/02

(57) ABSTRACT

Method of producing nanocellulose films, and multilayered laminate structures comprising nanocellulose films deposited on a substrate. According to the method a nanocellulose dispersion is applied on a surface of a substrate to form a layer, and the layer is dried on the surface of the substrate to form a film. According to the invention, the substrate comprises a fibrous substrate coated with release layer comprising for example silicone. The use of such a layer will allow for drying of the nanocellulose at increased temperatures of, for example at 140 to 210° C., whereby high-throughput production of nanocellulose films can be reached. The nanocellulose films can be used in paper packaging, energy storage, water treatment, biomedical engineering and pharmaceuticals.

### FIELD OF INVENTION

The present invention relates to the production of nanocellulose films. In such a method, a nanocellulose dispersion is applied on a surface of a substrate to form a layer, and the layer is then dried upon the surface of the substrate to form a film. The present invention also relates to nanocellulose films, in particular free-standing nanocellulose films, and their uses, as well as multilayered structures comprising nanocellulose films.

### BACKGROUND

The past decade has seen an exponential rise in applications related to nanocellulose which can be attributed to its outstanding properties, viz., abundance, renewability, biodegradability, biocompatibility and broad modification capability. The applications range from barrier packaging, flexible electronics, energy storage, water treatment, tissue engineering, wound healing and drug delivery. Most of these applications require nanocellulose as a free-standing film. And traditionally, the films are prepared by laboratory scale batch processes such as, solvent casting, filtration and draw-down coating, often followed by slow drying in ambient conditions.

In order to make the applications commercially viable, the films must be produced continuously at high speeds. Owing to its low solid's concentration and wet strength, high-throughput processing of nanocellulose always needs a supporting substrate that has high temperature tolerance. In addition, the substrate must be inert and allow for easy peeling off of the dry nanocellulose film. Known methods are disclosed in EP3397676A1 and US20140255688A1.

Current methods for producing nanocellulose films are time consuming and the throughput is small. This makes it very expensive to produce the films.

### SUMMARY OF THE INVENTION

It is an aim of the invention to eliminate at least a part of the problems relating to the art and to provide a new method of producing nanocellulose films.

The present invention is based on the idea of providing for the production of nanocellulose films, a substrate a fibrous material, such as a fibrous sheet or web, which can be coated with a hydrophobic layer, which will provide a release surface on the substrate after curing. A dispersion of nanocellulose in a dispersion medium can be applied on such a surface, the applied dispersion can be dried and the dried film thus obtained can be peeled off.

The method will provide for the manufacture of nanocellulose films which in the form of free-standing films are suitable for use in a large variety of applications.

The invention also provides a multilayered laminate structure, comprising a substrate layer having two opposite surfaces, the substrate layer being provided on one surface with a first layer of a hydrophobic material and on a second, opposite surface, with a second layer of a hydrophobic material, and further comprising a nanocellulose film layer deposited on the first layer of the hydrophobic material and, on the opposite surface, a glue layer deposited on the second layer of the hydrophobic material.

More specifically, the present invention is mainly characterized by what is stated in the characterizing portion of the independent claims.

Considerable advantages are obtained by the present invention.

Thus, by the present invention, nanocellulose films can be produced in large quantities very quickly. The use of, for example, a silicone release layer and a fibrous support will allow for drying of the nanocellulose at increased temperatures of, for example 140 to 210° C., whereby high-throughput production of nanocellulose films can be achieved. This makes it considerably much more inexpensive to produce such films than by conventional processes.

An advantage of using a release layer of the present kind is that the surface properties can be readily modified, Thus, a hydrophobic layer can be made temporarily less hydrophobic by for example a plasma or corona treatment to allow for the application on a nanocellulose dispersion on the surface. The layer will then regain is hydrophobicity over a limited period of time.

Further, it would appear that the recovery of the hydrophobicity of the release layer, in particular polymeric release layer, such as silicone is sped up at increased temperatures. Thus, during drying using temperatures in the range of more than 120° C., in particular about 140 to 210° C., the recovery speed of hydrophobicity of the release layer on the fibrous support is increased, which can be utilized by peeling off the film online.

Thus, by increasing temperature, production speed is increased both in terms of greater evaporation of the aqueous phase of the nanocellulose dispersion and in terms of a more rapid recovery of hydrophobicity of the release layer.

A further advantage of using a paper or paperboard substrate is that the substrate is suitable for printing. Thus, the surface of the substrate can be provided with various graphical symbols, such as marks or markings and patterns which can be utilized during coating of the surface and in the step of forming of the nanocellulose coating and of processing or modifying the latter coating. In fact, by producing the coating layer from a material which is transparent, and by coating such a layer with nanocellulose to form a film—which conventionally will be transparent—it is possible to see the graphical symbols of the substrate through the nanocellulose which can symbols can aid in the further processing of the nanocellulose film.

The nanocellulose films produced can be free-standing (self-standing) or they can be further treated or processed supported by the fibrous substrate. In one embodiment, multilayered laminate structures comprising one or more nanocellulose films deposited on a substrate are provided. Such laminates can be used for of the nanocellulose films as labels or self-adhesive films.

Embodiments of the invention find applications in paper packaging, energy storage, water treatment, biomedical engineering and pharmaceuticals, just to mention a few fields.

### BRIEF DESCRIPTION OF THE DRAWINGS

FIG. 1 shows in a schematic fashion the various steps of an embodiment of the present technology; and

FIG. 2 shows in a schematic fashion, in side-view, a substrate with silicone coatings on both sides.

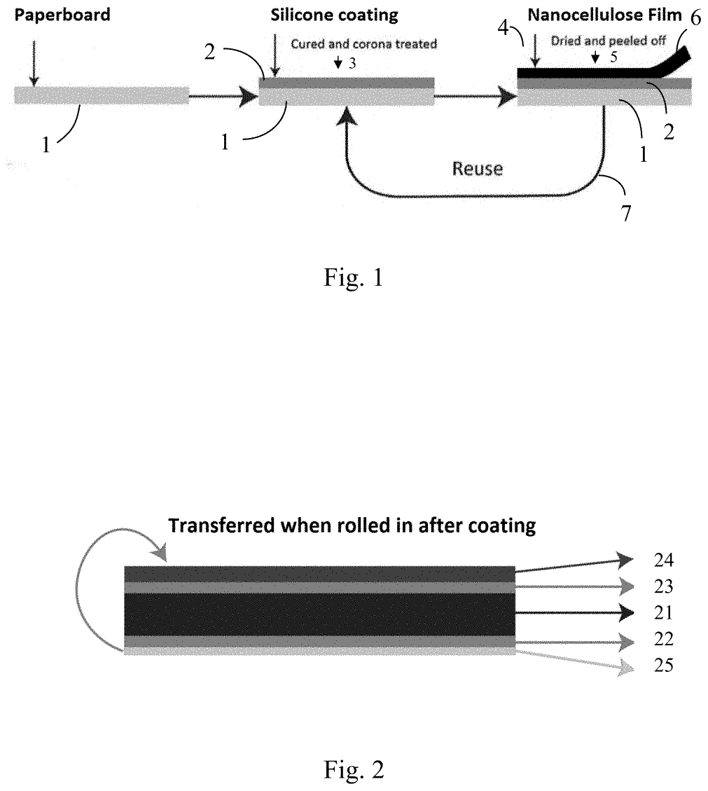

### Embodiments

In the present context, the term “dispersion” will be used synonymously with “suspension” for referring to solids-in-liquid compositions, in particular compositions of nanocellulose in water. Thus, in a preferred embodiment, nanocellulose is used in the form of aqueous dispersions, which optionally may contain additional components for adjusting the properties of the dispersions. Other protic liquids which do not work as solvents for the nanocellulose can also be used as dispersion media. Examples include aliphatic alcohols, such as C₁ to C₆ alcohols.

Embodiments of the present technology relate to the process flow to produce nanocellulose films by high-throughput.

In the following, embodiments will be described in which silicone is used as a release layer. However, it should be noticed that other materials can be used mutatis mutandis for achieving a suitable hydrophobic surface. Thus, generally, the hydrophobic release layer comprises a polymeric release layer selected from the group consisting of silicone, polyvinyl carbamate, acrylic ester copolymer, polyamide resin, octadecyl vinyl ether copolymer, hydrocarbon and fluorocarbon. The term “hydrophobicity material” stands for a material, such as crosslinkable silicone, which is capable of forming a hydrophobic surface on the substrate potentially after a chemical or physical reaction, such as cross-linking for example during curing.

In the present context, the terms “nanocellulose” and “nanocellulose component” stand in particular for cellulose nanofibers or microfibers or, generally, nanofibrils (CNF) which also is referred to as nanofibrillated cellulose (NFC) of microfibrillated cellulose (MFC).

The nanocellulose can also be bacterial nanocellulose, i.e. nano-structured cellulose produced by bacteria.

Typically, the nanocelluose exhibits fibrils having a fibril width of about 5 to 20 nm with a length of up to 25 mm. The aspect ratio for the nanocellulose fibrils ranges from 1 to 10,000, in particular 10 to 5,000, for example about 20 to 1500.

In the present context, the term “average particle size” refers to the D₅₀ value of the cumulative volume distribution curve at which 50% by volume of the particles have a diameter less than that value. The particle size can be determined by, for example, a laser diffraction particle size analyzer.

In the present context, the terms “glue” and “adhesive” are used interchangeably.

In one embodiment, the nanocellulose is applied in the form of a dispersion which comprises cellulose nano- or microfibrils, or cellulose nanocrystals.

In an embodiment, a hydrophobicity material, such as a crosslinkable silicone coating is applied onto a fibrous support. This silicone coating is cured, and then treated with corona to produce an inert surface with sufficiently high surface energy to allow for the spreading of wet nanocellulose suspension onto the surface, but low enough to allow subsequent peeling off of the dried film. Thus, a nanocellulose suspension is coated onto the substrate and the wet suspension is eventually dried by a combination of hot-air and infra-red dryers. The dried nanocellulose film is then peeled off like a sticker from the base substrate. The whole process can be incorporated into a single coating line, which allows for continuous production of nanocellulose film.

The various steps of a preferred embodiment, employing silicone as hydrophobic material, are also shown in the attached drawing.

In brief, as will appear from the drawing, the process starts with the provision of a suitable substrate 1 typically selected from papers and paperboards.

This substrate 1 is coated 2 with a crosslinkable silicone coating composition for example of the kind intended for siliconizing paper coatings and other substrates.

The silicone layer 2 is dried and cured, and then corona treated 3 to increase the surface energy, and the wettability of nanocellulose suspension.

Nanocellulose suspension 4 is applied onto this silicone-coated, corona-treated paperboard to form a layer, which is dried for example using a combination of hot-air and infra-red dryers 5.

The dried nanocellulose film is finally peeled off 5 like a sticker from the base substrate 1 coated with the silicone layer 2.

Instead of a crosslinkable silicone coating composition other hydrophobicity materials can be used.

The entire process can be incorporated into a single coating line to continuously produce nanocellulose films. Once the nanocellulose film 5 has been peeled off, the substrate can be reused 6.

In one embodiment, the substrate (reference numeral 1 of the figure) is a fibrous substrate comprising for example a sheet or web of a fibrous material. Such a material can be based on cellulosic or lignocellulosic fibers. The fibers can be derived from wood, in particular hardwood or softwood, or from perennial or annual plants.

In one embodiment, a cellulosic material based on chemical cellulose pulp is used.

In one embodiment, the material has a sufficiently good Scott bond to avoid delamination during a peeling-off of the nanocellulose film. In one embodiment, the Scott bond is at least 100 J/m² at a tensile strength (Z) of 25 J/m² or more.

In one embodiment, the fibrous substrate is selected from paperboards, in particular the substrate is a paperboard that has a grammage of at least 150 g/m², for example 160 to 850 g/m².

In one embodiment, the fibrous substrate is selected from papers having a grammage of at least 40 g/m².

In one embodiment, the substrate is selected from papers or paperboards, in particular paperboards, that meet one or several of the following criteria, viz. the paper or paperboard is sized, coated, calandered or lignin-free or a combination thereof.

In one preferred embodiment, the paperboard or paper has a coating of a pigment, for example calcium carbonate, titanium dioxide, kaolin, gypsum, barium sulphate or talc.

In one embodiment, the paper or paperboard has a coating layer has a coating ayer having a grammage of 1 to 50 g/m²/side, for example 2 to 25 g/m²/side.

A pigment-coated paper or paperboard is advantageous because it has a closed and/or smooth surface.

In one embodiment, the paper or paperboard has a smooth surface, which in turn results in a smooth coating of the hydrophobic material, such as silicone.

Thus, in one embodiment, the pigment-coated paper or paperboard has a closed surface which keeps the hydrophobic material, such as silicone on the surface and does not allow the composition of the hydrophobicity material, such as crosslinkable silicone coating composition, to penetrate into the paper or paperboard structure. This leads to savings in the amounts of the crosstinkable silicone coating composition used for coating.

In one embodiment, the surface of the substrate is non-permeable to gases.

In one embodiment, the surface of the hydrophobic coating is smooth and closed.

In particular, the smoothness (Gurley smoothness (porosity) value) of the surface of the substrate, such as paper or paperboard, having a hydrophobic coating, such as silicone, is at least 10,000 s, for example as least 20,000 s, such as at least 40,000 s, in particular 42,800 s or more. It can be determined with a paper testing device, such as L&W Air permeance tester.

In the present context, the term “silicone” or “polysiloxane” stand for a polymer that includes units of siloxane as main repeating unit in its polymer backbone. In addition, there are usually also reactive functionalities present on the polymer backbone of the silicone formulation that are capable of reacting and achieving crosslinking reactions. With the aid of the crosslinking reactions, a network structure is formed in the silicone system and a hardening of the silicone is achieved. The composition used for forming the silicone or polysiloxane is also referred to as “crosslinkable silicone coating composition” or briefly “silicone polymer composition.”

Typically, a crosslinkable silicone coating composition is applied on the substrate by spreading out the composition in liquid form on the surface of the substrate to form a crosslinkable silicone coating. After application, the crosslinkable silicone is hardened by curing at increased temperature or by using UV light treatment or both.

It is understood that during hardening of a crosslinkable silicone, a hydrosilylation reaction will take place in the formulation, comprising reaction of short polymeric chains of silicone to form a continuous polymeric network. The reaction is conventionally conducted in the presence of a catalyst. In the hydrosilylation reaction, short polymeric chains of silicone react with each other by crosslinking reaction to form a continuous polymeric network. The reaction typically further involves unsaturated functionalities, giving rise to alkyl and vinyl silanes and silyl ethers in the hardened silicone. To improve silicone adhesion to the substrate primers are employed.

The foregoing is just one possible explanation and the scope of the present invention is not limited to any particular mechanism for forming a silicone film. Also other types of release coating polymers can be used provided generally that they do not react with nanocellulose or have low surface energy.

In an embodiment of the process, the surface of the substrate is coated with a curable silicone resin (reference numeral 2 in the figure) to provide a surface having a water contact angle of more than 90° , in particular a water contact angle of 100° to 160°. The surface of the substrate is then subjected to a surface treatment, in particular a corona or plasma treatment.

In one embodiment, the silicone coating material is a polysiloxane, Typical examples include curable organo-polysiloxanes, such polydimethylsiloxane (abbreviated PDMS) and other silicone polymer materials used for coating paper substrates to produce release liners for stickers. In one embodiment, the polysiloxane used is selected from the group of organo-polysiloxanes capable of undergoing hydrosilylation reactions.

In an embodiment, the silicone coating polymer, such as organo-polysiloxane, such as PDMS, is solvent-free.

The silicone polymer composition applied onto the surface of the substrate typically contains, in addition to the silicone polymer component both a cross-linking agent and a catalyst to achieve proper cross-linking and curing. Typically, the amount of additives in the silicone polymer composition amounts to 0.1 to 10%, for example 1 to 5% by weight of the total composition.

The hydrophobic coating, such as silicone coating polymer, can be applied on the surface of the substrate by different coatings methods.

In one embodiment, the hydrophobic coating, such as silicone coating polymer, is applied to the substrate surface using a conventional coating process, such as reverse gravure coating.

In one embodiment, the hydrophobic coating, such as silicone coating polymer, is applied onto the substrate by curtain coating.

In one embodiment, the hydrophobic coating, such as silicone coating polymer, is applied onto the substrate by a continuous roll-to-roll process.

In one embodiment, the hydrophobic coating, such as silicone coating polymer, is applied onto the substrate by plasma-coating.

The hydrophobic coating, such as silicone coating, is typically applied upon the substrate at normal pressure and room temperature (at about 20 to 25° C.).

One embodiment comprises forming a hydrophobic coating, such as a silicone polymer resin layer, which has a thickness of at least 1 μm, preferably about 2 to 100 μm, in particular 10 to 25 μm.

One embodiment comprises forming a hydrophobic coating, such as a silicon polymer resin, layer which has a grammage of at least 5 g/m², in particular at least 10 g/m², for example at least 20 g/m², and typically up to 250 g/m².

In one embodiment, the hydrophobic coating, such as silicone coating, is cured for example at a temperature of 40 to 180° C., typically about 80 to 160° C., or by using UV light treatment or by a combination thereof.

In one embodiment, the hydrophobic coating, such as silicone coating, in particular cured silicone coating, is treated with corona or plasma to produce an inert surface with a surface energy that allows application of the nanocellulose suspension upon the surface while allowing for subsequent peeling-off of the dried film.

In one embodiment, the hydrophobic coating, such as silicone coating, in particular cured silicone coating, is subjected to a plasma treatment using N₂, Ar, O₂ or air (such as compressed air). Alternatively, the coating is subjected to a UV-ozone treatment.

In one embodiment, the hydrophobic coating, such as silicone coating, in particular cured silicone coating, is subjected to plasma coating, for example by roll-to-roll atmospheric plasma coating.

In a particular embodiment,
on the surface of the substrate there is applied a composition of a crosslinkable silicone polymer, which is cured to provide a silicone surface having a first water contact angle; and
the silicone surface is subjected to a treatment for reducing the surface energy thereof to provide a surface having a second water contact angle, the second water contact angle being smaller than the first watercontact angle, but less than 90°, for example 88 to 80°.

Corona treatment (reference numeral 3 in the figure) reduces the contact angle of silicone coated paperboard—or paperboard coated with another hydrophobic coating—by about 15 degrees from, for example 100° to 85°. This makes the surface slightly hydrophilic, which in turn facilitates the spreading and adhesion of wet nanocellulose coating.

After the treatment for lowering the surface energy of the hydrophobic coating, such as silicone coating, a nanocellulose dispersion is applied on a surface of the substrate to form a layer, and the layer is then dried on the surface of the substrate to form a film (reference numeral 4 in the figure).

It is to be noted that the effect of the surface energy reduction treatment is temporary; therefore, it is preferred to coat nanocellulose immediately after the corona treatment. Preferably, the time interval between the corona treatment and the application of nanocellulose dispersion on the surface is up to 600 s, in particular 0.001 s to 120 s.

The nanocellulose dispersion comprises cellulose nano- or microfibrils, or cellulose nanocrystals. The dispersion can also include additives, specifically plasticizers are often needed (examples: carboxymethylcellulose, sorbitol. glycerol). Typically, the amount of plasticizer is about 1 to 30% by weight of the weight of the nanocellulose dispersion.

In one embodiment, the nanocellulose dispersion is an aqueous suspension, in particular comprising 0.1 to 5% by weight of nanocellulose in water. However, it is possible to provide nanocellulose at higher solids contents in the dispersion. For example, the content of nanocellulose in the dispersion can amount to more than 2% by weight, such as more than 5% by weight or more, for example 10% by weight or more, 15% by weight or more and even higher, for example up to 30% by weight (calculated from the total weight of the suspension or dispersion).

Generally, for various nanocellulose grades, solids contents of about 2 to 30, in particular 2 to 10% by weight are preferred.

Typically, the nanocellulose dispersions have a high viscosity already at relatively low solids contents of, for example 3% by weight, and the viscosity increases with increasing solids content. Generally higher solids contents are still preferred to reduce the amount of water that needs to be evaporated for drying of the nanocellulose layer to form a film.

In one embodiment, the dynamic viscosity at 25° C. of the nanocellulose dispersion is in the range of 1 to 100,000 mPas, for example about 5 to 10,000 mPa·s, such as 10 to 1000 mPas or 10 to 500 mPas.

In one embodiment, the nanocellulose dispersion is applied onto the substrate using forced-feed. In one embodiment, the nanocellulose dispersion is applied onto the substrate using a die, in particular a slot-die for example supplied with a nanocellulose dispersion under pressure to allow for application of viscous dispersions. In one embodiment, the nanocellulose dispersion is applied onto the substrate using a die, in particular a slot-die, supplied using forced feed.

Examples of feeding means for used with a slot die include screw feeder and gear pump. With a slot die, dispersions having a high viscosity can be applied onto the substrate.

In one method, a method of producing a nanocellulose film, comprises the steps of
applying a nanocellulose dispersion on a surface of a substrate to form a layer, and
drying the layer on the surface of the substrate to form a film,

wherein
the substrate comprises a fibrous substrate coated with a hydrophobic release layer on the surface thereof and
the nanocellulose dispersion is applied at a solids content of at least 1 wt-% and up to 30 wt-%, typically 2 to 15 wt-% (calculated from the total weight of the dispersion) onto the surface of the hydrophobic surface using a die coater or applicator, in particular a slot-die coater or applicator.

In one embodiment, the wet coating thickness is adjusted by adjusting the gap between the application die, such as slot-die, and the paperboard. Larger gap leads to thicker coatings and vice-versa. The wet coating thickness is decided based on the targeted dry thickness of the film. In one embodiment, the wet coating has a thickness from 200 to 600 μm.

In one embodiment, the layer formed by application of the nanocellulose dispersion onto the surface of the substrate is dried by hot-air or infra-red radiation or a combination thereof

The drying of the layer (reference numeral 5 in the figure) is preferably carried out at an increased temperature. In the present context, the term “increased temperature” refers to a temperature in excess of 100° C., in particular in excess of 120° C., for example at about 140 to 210° C., such as 150 to 195° C. Naturally, the films can be dried at room temperature as well. The use of temperatures of about 100 to 220° C., or equal to or more than 120° C. and up to 210° C., will however considerably shorten the time needed for drying.

In one embodiment, the dried nanocellulose film (reference numeral 6 in the figure) peeled-off from the base substrate, recovered as a free-standing film and used as such, or modified, for various applications, as will be listed below.

As mentioned above, by drying of the nanocellulose at increased temperatures, hydrophobicity of the silicone coating will be restored rapidly, which allows for an embodiment, in which peeling-off of the nanocellulose film is carried out online.

In one embodiment, the present invention provides for the preparation of substrates for nanofilm production which are can be tailored to suit the requirements of high-throughput processing of a variety of nanocellulose suspensions into thin films.

Typically, the dried nanocellulose films have a thickness in the range of 1 to 500 μm, for example 2 to 250 μm, in particular 5 to 100 μm, such as 10 to 20 μm. The films can be “free-standing” which means that they are at least partially not in contact with support material while preferably still retaining structural integrity.

One embodiment comprises carrying out the various steps of the method by way of continuous operation for example on a single coating line, to allow for continuous production of nanocellulose film. In another embodiment, the nanocellulose films are produced in a batch process.

In one embodiment, the nanocellulose film left on the paper or paperboard substrate which forms a support for the film.

One benefit from having and keeping the paper or paperboard support with the produced nanocellulose film is that the support enables die cutting of the film into different sizes and shapes for the end use. This can be die cutting (“kiss cutting”) for example with a cylindrical or flat die (˜blade), where the film is cut but not the backing paper, or laser die cutting.

In one embodiment, a nanocellulose film left on the paper or paperboard substrate can be further coated or printed. The supporting substrate below the nanofilm, in particular a mechanically stiff substrate (a sheet which is stiffer than the nanocellulose), in particular paperboard, enables coating on the nanocellulose.

In one embodiment, the paper or paperboard substrate is provided, before coating with a release layer, with graphical symbols, in particular symbols selected from the group of marks, markings, lines, patterns, figures, photographs and letters or text or combinations thereof. Such graphical symbols can be printed on the paper or paperboard substrate. These graphical symbols will be visible through the release layer and through the nanocellulose film (after drying of the dispersion).

In one embodiment, a nanocellulose film, obtained as explained in the fore-going, can be left on the substrate until it is used. The print below the release layer and the nanocellulose film can provide, for example, instructions regarding further processing, e.g. by coating, lines for alignment, or instructions for cutting by hand.

In one further embodiment, the nanocellulose film is further coated or printed while keeping the nanofilm still supported on the mechanically stiffer substrate, such as paperboard. In such a way, for example an adhesive can be coated onto the nanocellulose film to produce transparent nanocellulose stickers. Further options include printing or applying in some other way of functional materials upon the nanocellulose. By applying glycerol or other polyols on the surface of the nanocellulose film it can be rendered adherent or sticky.

In one embodiment, partially wet, gel-like nanocellulose films can be prepared for example by incorporating UV-curable cross-linkers into the nanocellulose to achieve at least partial crosslinking during drying. In such an embodiment, it is preferred to keep the film upon the substrate working as a support up to the point where the film is subjected to its end use. Wound healing applications are an example of such uses.

In one embodiment, very thin nanocellulose films—having for example a thickness of less than 10 μm—which are not mechanically strong enough to be handled as free-standing films can be kept attached to the substrate, e.g. the paperboard support, until the film is used, e.g. until it is attached to a surface.

In one embodiment, the substrate comprises a reused substrate (reference numeral 7 in the figure), i.e. a substrate that has already at least once been used for the production of a nanocellulose film as described herein.

FIG. 2 shows an embodiment comprising a multilayered laminate structure, in the form of a sheet or—in particular—a web. The structure comprises a substrate layer, such as a pigment-coated paper or paperboard 21 as disclosed above, coated on opposite sides with layer 22, 23 of a hydrophobic material, such as a silicone polymer. On one side of the substrate 21, disposed upon the first hydrophobic layer 22, there is a nanocellulose film layer 24. On the opposite side, disposed upon the second hydrophobic layer 23, there is a glue layer 25. The glue may comprise any suitable adhesive, such as a hot melt adhesive or a pressure sensitive adhesive. In one embodiment, the adhesive is an acrylic adhesive. In particular, the adhesive will be of a kind which provides for a stronger adhesion between the adhesive and the nanocellulose film than the adhesion between the nanocellulose film and the silicon layer.

As will be seen from the drawing, by rolling or coiling of the multilayered structure 21 to 25, the adhesive layer 25 will adhere to the nanocellulose film 24, and upon uncoiling, the nanocellulose will be attached to the adhesive layer 25. Thus, the multilayered structure will upon uncoiling form a multilayered film, with a film layer 24—suitable for use as a label or self-adhesive film—adhered to an adhesive layer 25, which is removable attached to a release layer 23 formed by the hydrophobic material.

The embodiment of FIG. 2, provides for a simple a reliable solution for achieving a nanocellulose film, in particular a free-standing nanocellulose film, which can be transferred and attached to a selected object or surface by simply removing it from the release layer 23.

In the above description of embodiments, the hydrophobic release layer is illustrated by a silicone layer. It should be noted that, although this represents an advantageous embodiment, the release layer may also comprise other materials. In particular, the release layer comprises a material selected from the group consisting of polyvinyl carbamate, acrylic ester copolymer, polyamide resin, octadecyl vinyl ether copolymer, hydrocarbon and fluorocarbon as an alternative to or in addition to silicone.

Hydrocarbons, fluorocarbons and silicone materials can be applied on the fibrous substrate by plasma coating, for example employing low pressure (typically less than 10 mTorr).

### EXAMPLES

In the following, examples are given for producing a suitable substrate and for producing in particular two different types of nanocellulose films viz., cellulose nanocrystals (CNCs) and microfibrillated cellulose (MFC).

Step 1. Coating of Fibrous Support on Laboratory Scale

This, first step was the same irrespective of the type of nanocellulose used.

A roll of pigment-coated paperboard with a grammage of 200 g/m² and thickness of 270 μm was provided. The paperboard had a calcium carbonate coating on it. The paperboard was a commercial grade paperboard used for food packaging applications.

A silicone coating was applied on the surface of the paperboard using polydimethylsiloxane—in the following referred to by the abbreviation PDMS. The PDMS grade was Dehesive 924 (from Wacker Chemie) which has a viscosity of 350 mPa·s.

Right before coating, a conventional crosslinker for the PDMS and a platinum catalyst were added to the PDMS for initiating the curing process for the PDMS during coating. The formulation ratio was Dehesive 924:Crosslinker:Catalyst—100:2.9:1 (by weight). When all the components were sufficiently mixed, the resulting formulation was ready to be coated onto the paperboard.

A reverse gravure coating process was used for coating the PDMS formulation onto the paperboard. This was done in a continuous roll-to-roll process. The gravure rod had a surface volume of 65.6 cm³/m² and a mesh size of 80 lines per inch, which gave a coating thickness of around 15 μm.

The speed of the laboratory coater was set at 3 m/min and the gravure rod was set to rotate at 48 rpm (rotations per min). In order to get a uniform coating quality, the tangential velocity of the gravure rod was equal to or greater than the coater speed. The coating velocity was 3 m/min.

The PDMS coating composition was applied via the gravure rod onto the moving paperboard and the PDMS was cured until completely dry using a combination of Infra-red and hot air dryers at a temperature in the drying section of approximately 180° C.

This PDMS coated paperboard was then corona treated. Corona treatment reduced the contact angle of PDMS coated paperboard by about 15 degrees from 100° to 85°. This made the surface slightly hydrophilic, which in turn facilitated the spreading and adhesion of wet nanocellulose coating.

Immediately after the corona treatment, the silicone-coated substrate was used for nanofilm formation.

Step 2. Nanocellulose Coating on Laboratory Scale

In order to get a free-standing nanocellulose film, it should have thickness sufficient to provide the strength necessary to keep the film intact. This thickness is usually greater than 10 μm for most of the nanocellulose types. The final thickness is also governed by the intended end use of the film.

### Example 1

Depending on the nanocellulose's crystallinity, the films can be brittle. For example, CNCs have crystallinities over 90% and the films are extremely brittle. This may create difficulties in producing freestanding films. However, the brittleness can be reduced by adding plasticizers to the nanocellulose suspensions. The type and amount of plasticizer depends on the type of nanocellulose.

Thus, to make CNC films flexible, a plasticizer selected from sorbitol or glycerol was added to provide a concentration of 10-20% of plasticizer calculated from the total weight of the nanocellulose suspension.

### Example 2

For MFC films, carboxy methylcellulose can be used as a plasticizer. Typically, the concentration of it amounts to, for example 5% by weight in nanocellulose suspension, the percentage being calculated in relation to the nanocellulose. Other plasticizers, such as polyvinyl alcohol or latex, could be also used to get similar results.

Both types of films were produced from nanocellulose suspensions which were applied onto the silicone-coated substrate using a slot-die coater to allow for solids contents of 2.5 to 10% by weight. The nanocellulose suspension was fed from pressurized vessel into the slot die through a gear-pump specially designed to work with high viscosity suspensions.

The suspension coming out of the slot-die was applied immediately onto the corona-treated PDMS coated paperboard and dried on the coater using a combination of infra-red and hot-air dryers.

The wet coating thickness was adjusted by adjusting the gap between the slot-die and the paperboard. Usually the wet coating thickness was between 200 to 600 μm.

The coating speed was varied in the range from 3 to 10 m/min. The drying capacity of the laboratory scale coater was 43 kW.

The corona treatment helps to spread the wet nanocellulose suspension uniformly onto the PDMS surface and keeps it attached onto the surface temporarily.

The PDMS coating was found to be inert to nanocellulose and did not react with it. This allowed for ease of peeling off the dry nanocellulose film from the surface. Nanocellulose films having thicknesses in the range of 10 to 20 μm were produced.

A free-standing film was peeled off from the paperboard's surface, either online or offline and rolled separately. The paperboard, in this case was reused after another cycle of corona treatment.

It should be noted that although free-standing films are described here, the dry nanocellulose film can also be left adhered to the paperboard's surface if the end use requires some kind of support for the film

### LIST OF REFERENCE NUMERALS

1 Substrate

2 Silicone coating

3 Corona treatment

4 Nanocellulose suspension

5 Dryers

6 Free-standing film

7 Recycle of substrate

21 Substrate

22, 23 Silicone layers

24 Nanocellulose layer

24 Glue layer

### INDUSTRIAL APPLICABILITY

The current invention demonstrates the production of a substrate which is specially tailored to suit the requirements of high-throughput processing of nanocellulose suspensions into thin films. The dried film can be used in, for example, barrier packaging films, to provide for example gas, aroma and grease protection and combinations thereof.

Nanocellulose films of the present type have excellent mechanical properties, such as strength. In one embodiment, they have a specific modulus of 60-90 J/g. In comparison, steel and low density polyethylene (LDPE) have specific moduli of 25 and 2 J/g respectively. They also have a transparency of up to 90% which is on par with plastic films.

The present nanocellulose films can have high haze, although the present technology also allows for the manufacture of low-haze films.

High haze nanocellulose films are particularly useful in improving the efficiency of solar cells. Besides for use in solar cells, the high haze films can be used as light diffuser films, e.g. in lighting applications, due to, i.a., their high temperature tolerance.

Nanocellulose films are thermally stable up to about 250° C. Nanocellulose films exhibit excellent barrier against grease, oils, such as vegetable oils and mineral oils, and gases (especially oxygen). Further, nanocellulose can be hydrophobized by various surface modification techniques such as esterification, silylation, polymerization, urethanization, sulfonation and phosphorylation.

Nanocellulose is just pure cellulose molecule with little to no chemical modifications. This makes it 100% biodegradable and in addition, it is fully biocompatible. When it comes to food packaging, the excellent barrier properties of nanocellulose films together with their biodegradability make them suitable for replacing nonbiodegradable plastic packaging.

They can also be used in printed electronics, in colorimetry sensors, as transparent and conductive electrodes (using Ag nanowires) for touch screen panels and as strain sensors (combinations of nanocellulose and graphene). Other application fields include transparent flexible displays comprising for example OLEDs printed on nanocellulose. In energy storage applications, the nanocellulose films can be used in ionomer membrane for fuel cells and as anti-reflection coatings (ARCs) for solar cells.

Conductive nanocellulose films, produced by adding e.g. Ag nanowires, are similar in performance to ITO glass, which is currently used as electrodes in displays and solar cells. ITO glass is brittle and is made from rare earth metals, which require resource intensive mining. With the raising share of solar energy and with less than 50% of e-waste being recycled, conductive nanocellulose electrodes are an attractive alternate to ITO glass for the energy sector.

The nanocellulose films are also suitable for use in water treatment, tissue engineering, wound healing patches, drug delivery and as substrates for Raman scattering spectroscopy and as transparent fire -resistant films (comprising nanocellulose and silicates).

1. A method of producing a nanocellulose film, comprising the steps of:
applying a nanocellulose dispersion on a surface of a substrate to form a layer, and
dry ing the layer on the surface of the substrate to form a nanocellulose film.
wherein:
the substrate comprises a fibrous substrate coated with a hydrophobic release layer on the surface thereof.

2. The method according to claim 1, wherein the hydrophobic release layer comprises a polymeric release layer selected from the group consisting of silicone, polyvinyl carbamate, acrylic ester copolymer, polyamide resin, octadecyl vinyl ether copolymer, hydrocarbon and fluorocarbon.

3. The method according to claim 1, wherein the fibrous surface of the substrate is coated with the hydrophobic release layer to provide the surface with a water contact angle of more than 90°.

4. The method according to claim 2, wherein the hydrophobic release layer comprises silicone

5. The method according to claim 1, wherein the hydrophobic release layer on the surface of the fibrous substrate is subjected to a surface treatment to lower the surface energy thereof.

6. The method according to claim 1, wherein the release layer comprises silicone which is cured and treated with corona or plasma to produce an inert surface with a surface energy that allows application of layer comprising the nanocellulose dispersion upon the inert surface and that allows for subsequent peeling-off of the nanocellulose film formed by diving of the layer comprising the nanocellulose dispersion from the inert surface.

7. The method according to claim 1, wherein:
the surface of the fibrous substrate is coated with a crosslinkable silicone composition which is cured to provide a surface having a first water contact angle; and
the silicone surface is subjected to a surface energy lowering treatment to provide a surface having a second water contact angle, the second water contact angle being smaller than the first water contact angle.

8. The method according to claim 1, wherein the hydrophobic release layer has a thickness of at least 1 μm.

9. (canceled)

10. The method according to claim 1, wherein the hydrophobic release layer comprises a transparent or translucent film on the surface of the fibrous substrate.

11. The method according to claim 1, wherein the fibrous substrate comprises a paper or paperboard having a grammage of at least 150 g/m².

12. The method according to claim 1, wherein the fibrous substrate is pigment-coated paper or paperboard having a surface which is closed so as to prevent the penetration of the hydrophobicity material into the paper or the paperboard.

13. The method according to claim 1, wherein the substrate is paper or paperboard that meet one or more of the following criteria:
sized,
coated,
calandered, and/or
lignin-free.

14. The method according to claim 1, wherein the fibrous substrate comprises a sheet or web.

15. (canceled)

16. The method according to claim 1, wherein dried nanocellulose film is peeled-off from the base substrate online.

17. The method according to claim 1, wherein a free-standing nanocellulose film is produced.

18. The method according to claim 1, wherein the method is carried out by continuous operation on a single coating line to allow for continuous production of the nanocellulose film.

19. The method according to claim 1, wherein the process is carried out as a continuous roll-to-roll process.

20. (canceled)

21. The method according to claim 1, wherein the nanocellulose dispersion is an aqueous suspension comprising 0.1 to 30% by weight of nanocellulose in water.

22. (canceled)

23. The method according to claim 1, wherein the nanocellulose dispersion comprises cellulose nano- or microfibrils, or cellulose nanocrystals, optionally together with additives selected from the group consisting of carboxymethylcellulose, sorbitol, glycerol, and combinations thereof.

24. The method according to claim 1, wherein the drying of the layer is carried out at a temperature in excess of 120° C.

25. (canceled)

26. The method according to claim 1, wherein the fibrous substrate comprises a graphical symbol.

27. The method according to claim 26, wherein the graphical symbol is on the surface of the fibrous substrate before the fibrous substrate is coated with the hydrophobic release layer.

28. The method according to claim 26, wherein the graphical symbol is selected from the group consisting of marks, markings, lines, patterns, figures, photographs, letters, text, and combinations thereof.

29. The method according to claim 26, wherein the formed nanocellulose film comprises the nanocellulose substrate supported on the fibrous substrate having the graphical symbols, and wherein the graphical symbols are visible through the nanocellulose film.

30. The method according to claim 1, wherein the nanocellulose film has a thickness in the range of 1 to 500 μm.

31. The method according to claim 1, wherein the formed nanocellulose film is utilized as or in one or more of:
a barrier packaging film for gas, aroma and/or grease protection;
in printed electronics, in colorimetry sensors, transparent and conductive electrodes, touch screen panels, strain sensors, combinations of nanocellulose and graphene, in transparent flexible displays, OLEDs printed on nanocellulose;
for energy storage, ionomer membranes for fuel cells, or anti-reflection coatings for solar cells;
water treatment;
tissue engineering
wound healing patches;
drug delivery;
substrates for Raman scattering spectroscopy; and/or
transparent fire resistant films or films comprising nanocellulose and silicates.

32. A multilayered laminate structure, comprising
a substrate layer having two opposite surfaces,
the substrate layer being provided on one surface with a first layer of a hydrophobic material and on a second, opposite surface, with a second layer of a hydrophobic material, and
a nanocellulose film layer deposited on the first layer of the hydrophobic material and, on the opposite surface, a glue layer deposited on the second layer of the hydrophobic material.

33. The laminate structure according to claim 32, which is rolled or coiled such that the glue layer contacts the nanocellulose film layer.

34. The laminate structure according to claim 32, wherein the glue layer exhibits a greater adhesion to the nanocellulose film than the silicon layer on which the nanocellulose film is deposited.
